(19) United States
(12) Patent Application Publication
(10) Pub. No.: US 2014/0344673 A1
(43) Pub. Date: Nov. 20, 2014

(54) SYSTEM AND METHOD FOR ENHANCING INTERACTIVE ONLINE LEARNING TECHNOLOGY

(71) Applicant: LoudCloud Systems Inc., Dallas, TX (US)

(72) Inventors: Manoj Kutty, Dallas, TX (US); Anil Vishwanath Sonkar, Andheri (IN); Dinesh Madhavan Warrier, Mumbai (IN); Ramesh Babu Chowdaiah Tatimatla, Guntur (IN); Aniruddha Dutta Chowdhury, Kolkata (IN)

(73) Assignee: LoudCloud Systems Inc., Dallas, TX (US)

(21) Appl. No.: 13/897,633

(22) Filed: May 20, 2013

(51) Int. Cl. G06F 17/22

(52) U.S. Cl. CPC G06F 17/2247
USPC 715/236

(57) ABSTRACT

Disclosed is a method and system for enhancing interactive online learning technology. In one embodiment, the document transformation module transforms the input document in an extensible markup language (XML) format. The document parser module parses the input document transformed using an extensible style sheet language transformation (XSLT). The navigation file creation module creates a navigation order between a plurality of content in the input document parsed, wherein the navigation order is created to describe a relative path between the contents. The asset file creation module creates an asset file, wherein the asset file is created based on the relative path between the contents. The tagging module tags the contents in the input document transformed. The repository stores the input document transformed comprising: the navigation order, the asset file and the tags, in a repository and the interface enables a user to communicate with other user on the system using the stored document.

### TECHNICAL FIELD

The present subject matter described herein, in general, relates to a field of online learning technology, and more particularly to a system and method for enhancing an interactive online learning technology.

### BACKGROUND

An interactive online learning system may provide computer-based training (CBT). CBT is a field of learning in which a user learns by implementing training programs on a computer. A content creator or administrator may be a person who is responsible for feeding learning content to the CBT system. Sometimes, the content creator may be only responsible for overall process of converting the content to a format compatible with the online learning system and CBT techniques, and may insert information relating to the most commonly asked questions by the users related to the contents; but the creator may not anticipate all questions or problems. A skilled educator or any authorized instructor/tutor can react to a considerably larger collection of problems as well as provide greater flexibility to the students' changing needs.

Conventional CBT also requires the users to be in the same geographic location as the educator. CBT may be adapted for use with a computer network such as the Internet. Some schools or institutions provide assistance over the World Wide Web wherein pre-stored presentations (text, audio, and video) are made available for knowledge seekers. The interaction between the teacher and student may be facilitated in asynchronous fashion. For example, students may submit questions which will be answered by the teacher at a later time, or a chat session may be hosted by the teacher at a designated time period. However, there may be no direct assistance from the teacher to the student. The students for maximum times must satisfy the need on their own.

### SUMMARY

This summary is provided to introduce aspects related to systems and methods for enhancing interactive online learning technology and the aspects are further described below in the detailed description. This summary is not intended to identify essential features of the claimed subject matter nor is it intended for use in determining or limiting the scope of the claimed subject matter.

In one implementation, a system and method for enhancing interactive online learning technology is disclosed. The interactive e-learning system comprises a processor and a memory coupled to the processor for executing a plurality of modules in the memory. The plurality of modules comprises a document transformation module, a document parser module, a navigation file creation module, an asset file creation module and a tagging module. The document transformation module is configured to transform at least one input document in an extensible markup language (XML) format. The document parser module is configured to parse the at least one input document transformed using an extensible style sheet language transformation (XSLT). The navigation file creation module is configured to create a navigation order between a plurality of contents in the at least one input document parsed, wherein the navigation order is created to describe a relative path between the plurality of contents. The asset file creation module is configured to create an asset file, wherein the asset file is created based on the relative path between the plurality of contents. The tagging module is configured to tag the plurality of contents in the at least one input document transformed to generate a plurality of tags. The memory further comprises a repository. The repository is configured to store the input document transformed comprising the navigation order, the asset file and the plurality of tags. The system further comprises an interface enabling at least one user to communicate with at least one other user on the interactive e-learning system using the plurality of contents in the at least one input document stored.

In another implementation, a method for transforming at least one input document with a source format to a document compatible with an interactive e-learning system, the method comprises of transforming the input document in an extensible markup language (XML) format. The input document transformed is then parsed using an extensible style sheet language transformation (XSLT). The input document parsed is then used for creating a navigation order between a plurality of contents in the document wherein the navigation order is created to describe a relative path between the contents. The asset file is created based on the relative path between the contents. The contents in the input document transformed are further tagged. The input document transformed comprises the navigation order, the asset file and the tags, is stored in a repository. At last, the interface enables at least one user to communicate with at least one other user on the interactive e-learning system using the plurality of contents in the at least one input document stored.

In yet another implementation, a computer program product having embodied thereon a computer program for transforming at least one input document with a source format to a document compatible with the interactive e-learning system, the computer program product comprises instructions for: transforming the input document in an extensible markup language (XML) format; parsing the input document transformed using an extensible style sheet language transformation (XSLT); creating a navigation order between a plurality of content in the input document parsed, wherein the navigation order is created to describe a relative path between the contents; creating an asset file, wherein the asset file is created based on the relative path between the contents; tagging the contents in the input document transformed; storing the input document transformed comprising: the navigation order, the asset file and the tags, in a repository; enabling at least one user to communicate with at least one other user on the interactive e-learning system using the plurality of contents in the at least one input document stored through an interface.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of an interactive e-learning system for enhancing interactive online learning technology is shown, in accordance with an embodiment of the present subject matter.

FIG. 2 illustrates an interactive e-learning system, in accordance with an embodiment of the present subject matter.

FIG. 3 illustrates the interactive e-learning system for enhancing interactive online learning technology is shown, in accordance with an embodiment of the present subject matter.

FIG. 4 illustrates the interactive e-learning system with a specialized tagging module of the interactive e-learning system for enhancing interactive online learning technology is shown, in accordance with an embodiment of the present subject matter.

FIG. 5 illustrates a method for enhancing interactive online learning technology is shown, in accordance with an embodiment of the present subject matter.

FIG. 6 illustrates a screenshot for a communication with the interactive online learning system by selecting text, the user can view tool tip options for creating “I don't get this”, in accordance with an embodiment of the present subject matter.

FIG. 7 illustrates a screenshot displaying the action after clicking of “I don't get this” option user can see a window displayed to the user, in accordance with an embodiment of the present subject matter.

FIG. 8 illustrates a screenshot displaying a link getting placed for “I don't get this” created by the user, in accordance with an embodiment of the present subject matter.

FIG. 9 illustrates a screenshot for communication with the interactive online learning technology using “Take a quiz” option, in accordance with an embodiment of the present subject matter.

FIG. 10 illustrates a screenshot for displaying the action after user clicks on “Take a quiz” link, in accordance with an embodiment of the present subject matter.

FIG. 11 illustrates a screenshot for displaying the action after user clicks on the Quiz listed in the window, in accordance with an embodiment of the present subject matter.

### DETAILED DESCRIPTION

Systems and methods for enhancing interactive online learning technology are described. In some embodiments, an interactive online learning system may display a plurality of contents on a user interface in a specific format compatible to the interactive online learning system. Such a system may provide an effective and efficient mechanism for enhancing interactive online learning technology. Based upon the plurality of contents, a plurality of users may interact with the system. In one example, based on the contents displayed on the interface of the system, a user may interact with the system by selecting the content. Subsequently, if the user selects the content for attaching an annotation, the annotated content may be automatically displayed on a side bar present on the user interface of the system, for communication between the other users on the system.

To display the plurality of content on the user interface in the specific format compatible to the system, at first, a plurality of input documents with a source format may be fed to the system. Specifically, the input documents may be in rich text file format, Microsoft word file format, plain text file format, Microsoft power point file format, portable document format (PDF) file format, electronic publication (ePub) file format, Docbook documentation and the like document file format.

The content to be displayed on the system must necessarily be in the specific format compatible to the system. The documents may be fed in any format to the system. The system on receipt of the documents of the source format is configured for automatically converting the documents into the specific format compatible to the system. In one example, the content may be provided for display on an e-reader application which may be hosted on the interactive e-learning system. The e-reader application for desktops and mobile devices allow the reading of eBooks and other documents stored in the interactive e-learning system. In the system, the conversion may be implemented for the e-reader application usage, using a document converter tool called “lb converter”. This conversion follows a proprietary LB schema, which may be derived from the Docbook™ and the ePub™ schema. Using this document convertor tool, the content of any format may be converted to the LB format i.e., in the specific format compatible to the system.

After all the input documents with the specific format are converted to the documents compatible with the system, the content present on the transformed document may be further used for communication between the plurality of users on the system. In one example, the communication may be achieved using various ways selected from the group comprising of: discussion forum, chat room, real time discussion, or by posting a query related to the at least one content present in converted document to the other user.

In one implementation, said users may be selected but not limited to the group comprising of students, instructors, tutors, and administrators.

While aspects of described system and method for enhancing interactive online learning technology may be implemented in any number of different computing systems, environments, and/or configurations, the embodiments are described in the context of the following exemplary system.

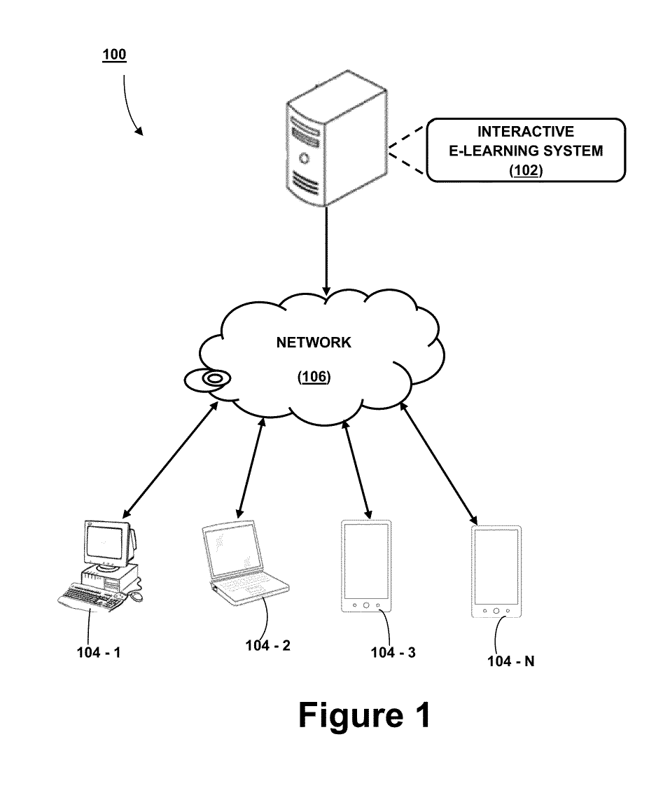

Referring now to FIG. 1, a network implementation 100 of an interactive e-learning system 102 for enhancing interactive online learning technology is illustrated, in accordance with an embodiment of the present subject matter. In one embodiment, the interactive e-learning system 102 may provide a method for transforming at least one input document with a source format to a document compatible with an interactive e-learning system, the method comprises of transforming the input document in an extensible markup language (XML) format. The input document transformed may be then parsed using an extensible style sheet language transformation (XSLT). The input document parsed may be then used for creating a navigation order between a plurality of contents in the document wherein the navigation order may be created to describe a relative path between the contents. The asset file may be created based on the relative path between the contents. The contents in the input document transformed may be further tagged. The input document transformed may comprise the navigation order, the asset file and the tags, and may be stored in a repository. At last, the contents in the stored input document may be used for communicating at least one user with at least one other user on the interactive e-learning system through an interface.

Although the present subject matter is explained considering that the interactive e-learning system 102 is implemented as a interactive e-learning system on a server, it may be understood that the interactive e-learning system 102 may also be implemented in a variety of computing systems, such as a laptop computer, a desktop computer, a notebook, a workstation, a mainframe computer, a server, a network server, and the like. It will be understood that the interactive e-learning system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 may be communicatively coupled to the interactive e-learning system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network may represent an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

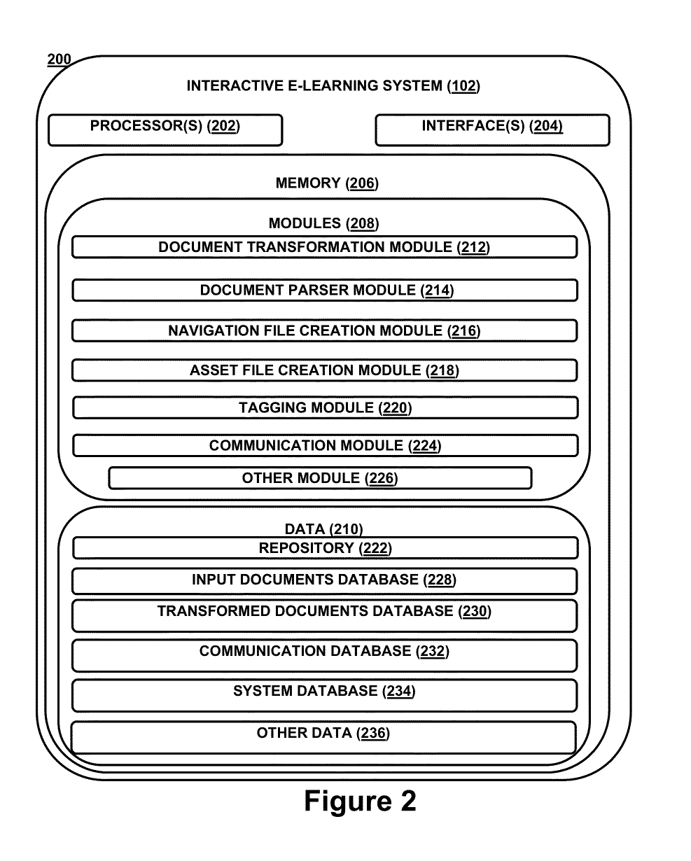

Referring now to FIG. 2, the interactive e-learning system 102 is illustrated in accordance with an embodiment of the present subject matter. In one embodiment, the interactive e-learning system 102 may include at least one processor 202, an interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The interface 204 may include any input/output interface including a variety of software and hardware interfaces, for example, a web interface, a graphical user interface, and the like. The interface 204 may allow the interactive e-learning system 102 to interact with a user directly or through the client devices 104. Further, the interface 204 may enable the interactive e-learning system 102 to communicate with other computing devices, such as web servers and external data servers (not shown). The interface 204 can facilitate multiple communications within a wide variety of networks and protocol types, including wired networks, for example, LAN, cable, etc., and wireless networks, such as WLAN, cellular, or satellite. The interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, etc., which perform particular tasks or implement particular abstract data types. In one implementation, the modules 208 may include a document transformation module 212, a document parser module 214, a navigation file creation module 216, an asset file creation module 218, and a tagging module 220, a communication module 224 and other modules 226. The other modules 226 may include programs or coded instructions that supplement applications and functions of the interactive e-learning system 102.

The data 210, amongst other things, may serve as a repository for storing data processed, received, and generated by one or more of the modules 208. The data 210 may also include a repository 222, an input documents database 228, a transformed documents database 230, a communication database 232, a system database 234, and other data 236. The other data 130 may include data generated as a result of the execution of one or more modules in the other module 226.

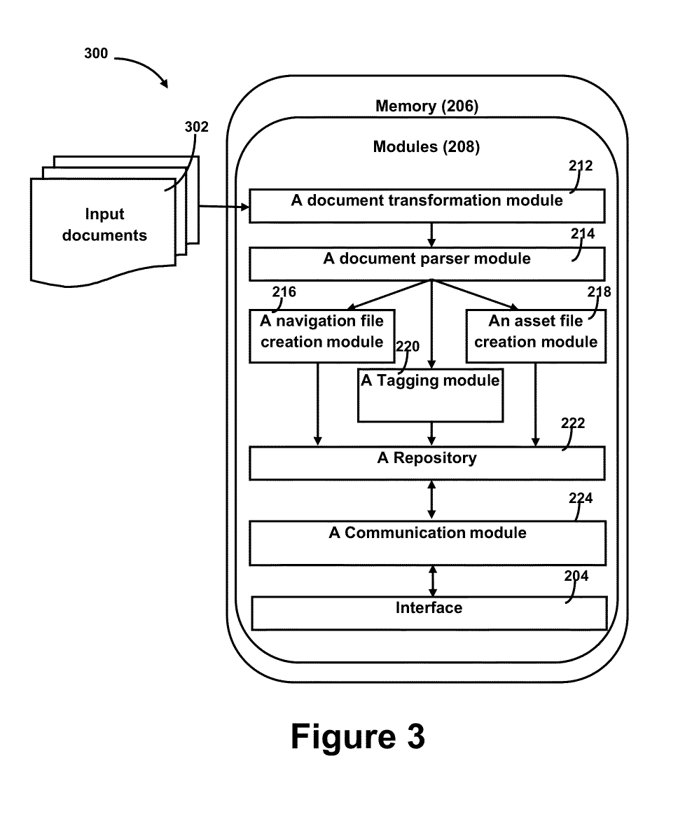

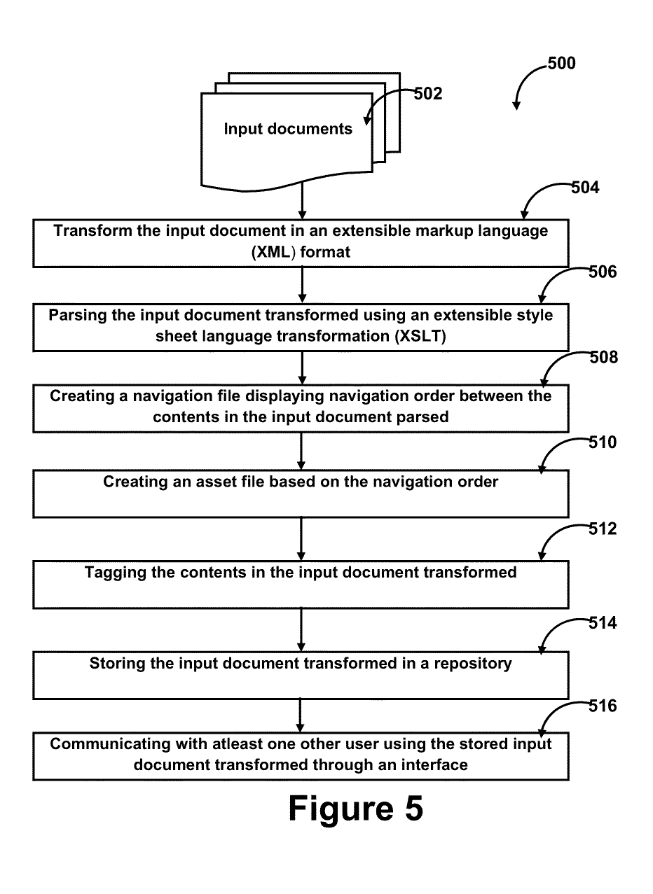

In one implementation, at first, a user may use the client device 104 to access the interactive e-learning system 102 via the interface 204. The user may register by using the interface 204 in order to use the interactive e-learning system 102. The working of the interactive e-learning system 102 is explained in detail in FIGS. 3 and 5 explained below. The interactive e-learning system 102 may be used for enhancing the online learning system. In order to enhance the online learning system, the interactive e-learning system 102, at first, transforms the plurality of input documents in the system compatible format. Specifically, in the present implementation, the transformation of the input documents may be performed by the various modules present in modules 208.

### Document Transformation Module 212

Referring to FIG. 3, a detailed working of the document transformation module 212 along with the working of other components of the interactive e-learning system 102 is illustrated, in accordance with an embodiment of the present subject matter. In one implementation, in order to transform the plurality of input documents 302 stored in the input documents database 228, the document transformation module 212 may, at first, transform the input documents in an extensible markup language (XML) format. The transformed documents may be stored in the transformed documents database 230.

In one implementation, the document transformation module 212, after receiving the plurality of input documents with the source format 302, may use an extensible style sheet language transformation (XSLT) for the transformation. The XSLT may be one of the conventional languages for transforming any document with source format into the XML document, or other objects such as HTML, plain text or into XSL Formatting Objects and the other document formats. The input documents may be XML files or any other documents with any format. The original document may be not changed during the transformation; rather, a new document may be created based on the content of an existing one. XSLT may be considered as a complete turing language, which can perform any calculation that can be performed by a computer program.

As soon as the plurality of input documents 302 are received by the system, all the data related to the input documents may be stored in the input documents database 228. For example, the input documents database 228 may include the data like the document size, document title, time and date of feed and the like data. The data related to the transformed documents from the document transformation module 212 may be stored in the transformed documents database 230. For example, the transformed documents database 230 may include the data like document size after transformation, the time taken for transformation and the like.

### Document Parser Module 214

After transforming the input documents in XML format, the next step may be to parse the transformed document available in order to create a navigation order, an asset file and to tag the contents, in the input document transformed.

Referring now to FIG. 3, the working of the document parser module 214 is illustrated, in accordance with an embodiment of the present subject matter. At first, in order to parse the input document transformed, in one example embodiment, the input document transformed must be in XML format. In one implementation, the XML document may be parsed using the XSLT, which may generate the desired HTML document with customized presentation mark-up and the data related to this parsing may be stored in the system database 234.

In one implementation, the system database 234 may store the data related to the document parser module 214.

### Navigation File Creation Module 216

In one implementation, a navigation XML file may be created as the output of the document parser module 214. The navigation XML file describes a navigation order between the multiple contents in the input documents parsed. The navigation order may be created to describe a relative path between the contents. This navigation XML may also store the display title for each content document. The navigation XML may also describe the hierarchical relationships in terms of a navigation tree between the multiple parsed documents. In one implementation, the relative path to the navigation XML may be accessed using various ways selected but not limited from the group comprising of: a uniform resource locator (URL) and a static link object.

In one implementation, the system database 234 may store the data related to the navigation file creation module 216. The data may include information related to the display title for each content document, the relative path between the contents, and hierarchical relationships in terms of the navigation tree between the multiple parsed documents.

### Asset File Creation Module 218

The asset file may be created based on the relative path between the contents. Each transformed document may be referred using its relative path to navigation XML. In one implementation, the asset file enables the transformed documents having the assets required to render the content documents to store outside the content document at other location. The assets may be referred to in the content document using relative paths.

In one implementation, the system database 234 may store the data related to the asset file creation module 218. The data stored may include the relative path to navigation XML.

### Tagging Module 220

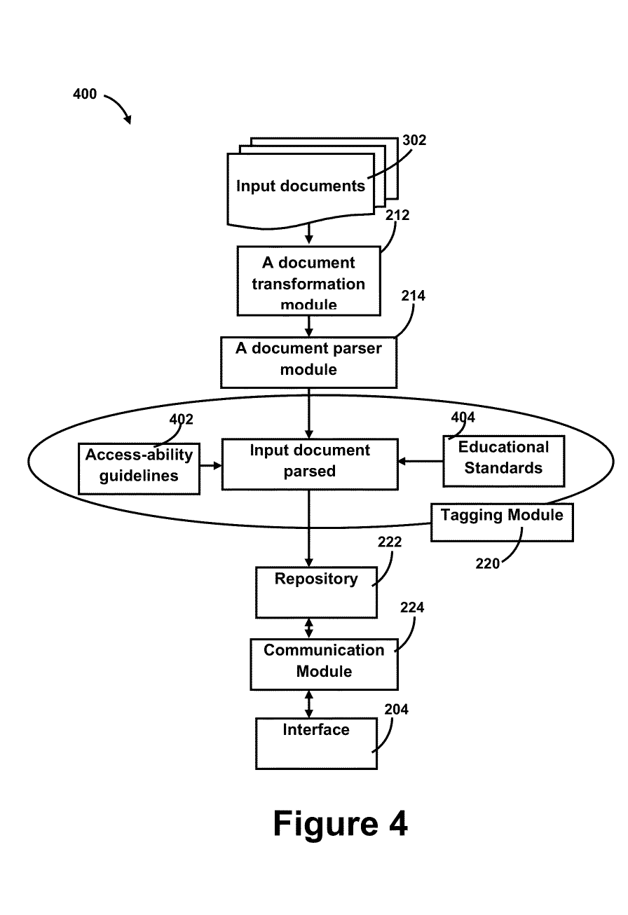

Tag allocation module 220 may enable the system to tag the plurality of contents in the input document transformed. The content in the input document may be selected from the group comprising of: a text, an audio, a video, an animation, an image. The detailed description for the tag allocation module 220 is explained in the explanation of FIG. 4.

In one implementation, the system database 234 may store the data related to the tagging module 218. The data stored may include the tag details with the respective content information. In one example, the database 234 may include the tag details like the tag number or value, the content, the document name of which the content is present and the like.

### Repository 222

The navigation XML file, the content document and the asset files, created by the navigation file creation module 216, the asset file creation module (218) and the tagging module 220 respectively, may be stored in a repository 222. The navigation XML document may be stored at the top level of this repository 222, while the other files may be stored in a plurality of sub-repositories of the repository 222. In one example, the repository 222 may be created specifically for generating the “lb” format for the source content of the e-reader application. This repository 222 may not contain any other files apart from the files required to create the “lb” file. The repository 222 which stores the “lb” content documents may be then compressed using the zip compression standard such that on uncompressing, the navigation XML file may be directly accessible under the uncompressed target repository path. This compressed file may be stored in the content repository for access by the e-reader application. In one example, in the e-reader application the navigation XML document may be named as toc.XML as a standard.

In one implementation, the system database 234 may store the data related to the repository 222. The data may include the information related to the files with their title, date and time of creation and the like details.

### Communication Module 224

The communication module 224 enables the plurality of users to communicate with at least one other user on the interactive e-learning system using the contents in the stored input document transformed through the interface 204 of the system. In one implementation, the system 102 may enable the user to annotate the content by highlighting a section of the content or adding custom note, web-links, or multimedia to a section of the content. The annotations may be stored with the content. In one example, the system 102 may archive this functionality by using the document object model of the browser. The system 102 may listen to the events provided by the browser to show a context menu above the content. To annotate, the system 102 may insert custom mark-up in the rendered document at the location specified by the user. The system 102 may identify the location of injecting the mark-up by leveraging the built in functionality provided for different browsers. The custom mark-up may be specific to each browser to compensate for the idiosyncrasies of the browsers DOM. The system 102 may control access to the annotations shared by the users by implementing privileges granted to the user of the contents in the transformed document.

In one implementation, the communication between the users may be by allowing the user to post a query related to the at least one content present in input document transformed, by selecting it, to the other user. In one example, if the content displayed on the e-reader application is “When life gives you a hundred reasons to cry, show life that you have a thousand reasons to smile”. The user may find it very difficult to understand the meaning of this sentence. The user can select the content i.e. the whole sentence in this case, and mark it as “I don't get this”. As soon as the user marks it as “I don't get this”, the sentence may be forwarded to an authorized user of the system 102. The authorized user may be selected from the group comprising of students, instructors, tutors, and administrators. In one example, the “I don't get this” feature may enable the user to post a query related to any content present in the “lb format” document on the e-reader application. The query can be posted to the authorized user such as the instructor on the system 102. In one example, if any student is unable to understand any particular content present on the document, the student can select the particular content and mark it as “I don't get this”. This particular content/query may be directly posted to the instructor/tutor/respected authority of the institution present on the system 102.

In one implementation, the communication between the users may be by allowing the user to appear for a quiz embedded in the content displayed on the screen, while the user is reading the content itself. The quiz may be embedded during the creation of transformed document. In one implementation the quiz may further comprise various types of question selected from the group consisting of: multiple choice question, fill in the blank, descriptive question. In another implementation, the quiz can be a graded quiz or an ungraded quiz. The graded or ungraded quiz may be decided by the authorized user, during the embedding of quiz process. In one implementation, the quiz enables the user to view/answer the quick short questions that may be MCQs or fill in the blanks etc., related to the content read by the user. The questions may be fed manually while uploading the transformed documents in the e-reader application by the administrator or the instructor.

In one example, the communication may be initiated between the plurality of users in the system 102 that may be willing to help the user and connected to the same system but located at different locality. This communication feature may enable the user to get assistance related to his “I don't get this” query as soon as possible in very less time.

In one implementation, the user while communicating, by solving the quiz and have some query related to the quiz, the user may need an immediate assistance from the authorized users on the system for solving the query. The query may be any content present on the transformed document or the quiz document. This can be accomplished by sending the query to the users in the class. In one example, the query from the user related to the content present on the transformed document may be displayed to the authorized users present on the system.

In one implementation, the users can delete, assign substantive rating, like a post, like a thread, archive a useful reply or thread, tag responses to archive, for the content which may be posted by the user as a query using “I don't get this” feature.

In one implementation, the query posted by the user can be highlighted by the authorized users, if the content and the related information are important and can be shared with the other users. The system 102 also may enable the user to archive the query and related information. Further, the query and the related information may be marked as high quality post based on the query reply on the content posted by a flag, a like, any other making option and the like.

In an implementation, based on the query posted by the user, the system 102 may automatically identify a user expert in a particular domain for replying to that particular query. The user expert in the particular domain may be selected form the group of authorized users pre-stored in the database of the system 102. In another implementation, an administrator of the system 102 may also assign the user expert for replying to the particular post.

In an implementation, the system 102 may also enable a plurality of other users to willingly register for providing the services in order to solve the query posted by multiple users. The plurality of other users may include but not limited to an retired professor/tutor from the institution, a skilled person in a respective domain for example, any information technology engineer for software engineering queries, and the like. The other users may be approved by the administrator based on the qualification and other required eligibility criteria set by any institution in order to be an authorized user. The system 102 may enable the registered user to share their availability for online chat and help on the system 102. The system 102 also may enable the needy user seeking for online assistance to schedule the assistance from the other users. The system 102 further may enable to rate the live sessions and archive them and make it available for future use.

In one implementation, the authorized user may be selected form the group comprising of instructors, tutors, and administrators of the institution.

In one implementation, all the data related to the communication module 224 may be stored in the communication database 232. The data may include the date and time for adding the annotation to the content, the content related information like location of content on the document, the users information like sender and receiver users information like name, time for sending, the content send etc. and the like information.

In one implementation, the system 102 can be implemented as an e-reader device. The e-reader device may load the .lb document stored in the repository 222 via. Http request. To load an .lb document, the e-reader device may call the link from the toc.XML document. The e-reader device sends a request for the navigational XML document to the application server using the link. After the navigation XML is received, the e-reader device may parse the document and creates an internal object model to store the navigation tree. The e-reader device may initialize the navigation UI (the previous and next links) based on the number of nodes in the navigation tree and constantly update the UI state based on the currently loaded document. The e-reader device then may load the document that is on the top of the tree using the URL defined in the navigational XML. The e-reader device may monitor the loading process of the document and set the height of the frame of the document according to the content, to be displayed on the e-reader device. The e-reader device also may load the communication information like quiz or any annotations for all the content documents accessible to the user role and show the list of annotations for currently loaded document. The user may be presented with the icons that denote the type of annotations. These icons may be placed at the start of the logical text blocks that contains the annotated content. Icons for non-contextual contents may be shown at the top of the documents. The user can also interact with the highlighted content using context menu.

Referring now to FIG. 4, illustrates the interactive e-learning system with a tagging module of the interactive e-learning system for enhancing interactive online learning technology is shown, in accordance with an embodiment of the present subject matter.

In one implementation, the input documents with the source format 302 may be fed to the system for transformation. The document transformation module 212 may transform the plurality of input documents with source format into the parsed XML document. Further, the parsed input document may be fed to the tagging module 220; wherein the system may provide many tags that can be used to tag contents present on the parsed document. These tags may help in rendering the tagged content with distinct behavior and appearance. The tags may also be used to analyze the actions performed with the tagged content. In one implementation, based on the analysis of action, the system can recommend supplementary content for the user. The system may contain elements that help to implement accessibility guidelines 402 in the transformed content documents. This may help the e-reader application hosted on the e-learning system in rendering the content in most suitable format for users who face challenges in using typical input and output devices. The LB Content Mark-up may contain elements that identify content that has been mandated as to fulfill certain educational standards 404 that may have been prescribed by the district or the state boards. Tagging content with these elements may help learners identify which content meets which Education Standards 404. These elements may be also used to tag content used for assessments so that a performance of a plurality of users can be mapped to specific educational standards which can then be highlighted in the result. The system may provide a rich set of elements and attributes for tagging content that will be rendered as multimedia content in the e-reader application. This type of tagging may enable the system 102 to identify the users' learning style and then recommend content best suited to the identified style.

Referring now to FIG. 5, a method 500 for enhancing interactive online learning technology is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions may be performed by remote processing device that may be linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented in the above described media system 102.

At block 502, at least one input document with a source format may be fed to the system 102.

At block 504, at least one input document with a source format may be transformed in an extensible markup language (XML) format. In one implementation, the input document with the source format may be transformed by the document transformation module 212.

At block 506, parsing the input document transformed using an extensible style sheet language transformation (XSLT) may be performed. In one implementation, the parsing may be performed by the document parser module 214.

At block 508, a navigation order between a plurality of contents in the input document parsed may be created, wherein the navigation order may be created to describe a relative path between the contents. In one implementation, the navigation file may be generated by the navigation file creation module 216.

At block 510, an asset file may be created based on the relative path between the contents. In one implementation, the asset file may be created by the asset file creation module 218.

At block 512, tagging the contents in the input document transformed may be performed. In one implementation, the tagging may be performed by the tagging module 220.

At block 514, storing the input document transformed comprising: the navigation order, the asset file and the tags, in a repository 222 may be performed. In one implementation, the storing may be performed by the repository 222.

At block 516, at least one user may be enabled to communicate with at least one other user on the interactive e-learning system using the stored input document transformed. In one implementation, the communication may be carried out by the interface 204.

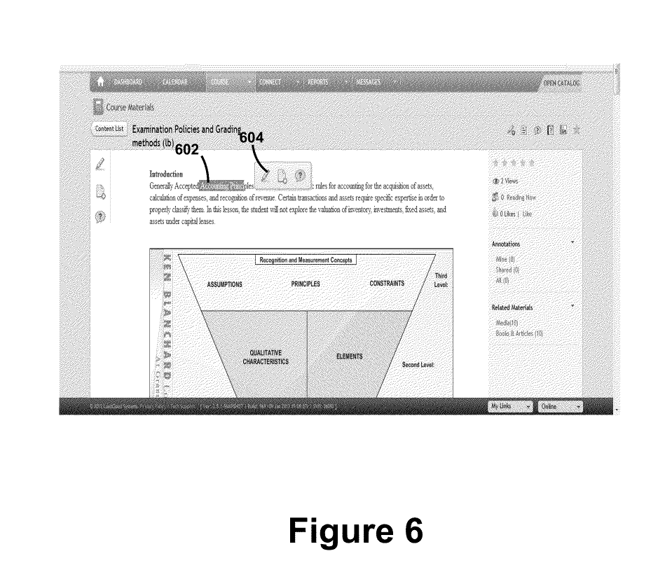

FIG. 6 illustrates a screenshot for a communication with the interactive online learning system by selecting some text 602, the user can view tool tip option 604 for creating “I don't get this”, in accordance with an embodiment of the present subject matter. In one implementation, user may select some text displayed on the interface of the e-reader application. After selecting the text, the user can view tool tip options for creating “I don't get this”.

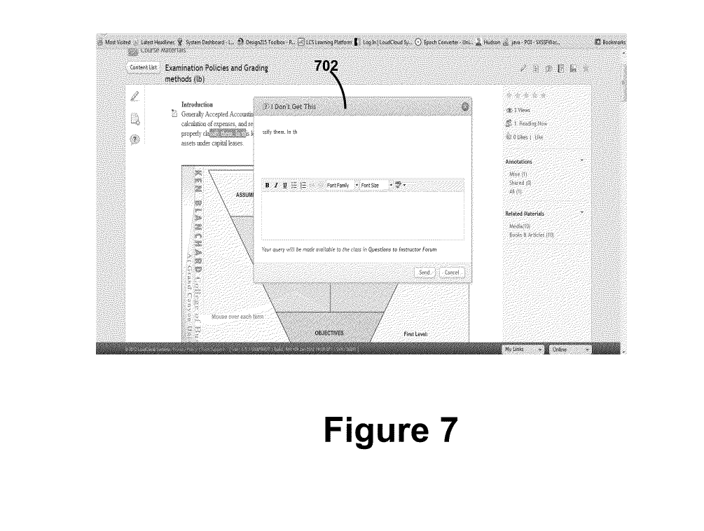

FIG. 7 illustrates a screenshot displaying the action after clicking of “I don't get this” option 604 user can see a window 702 displayed to the user, in accordance with an embodiment of the present subject matter.

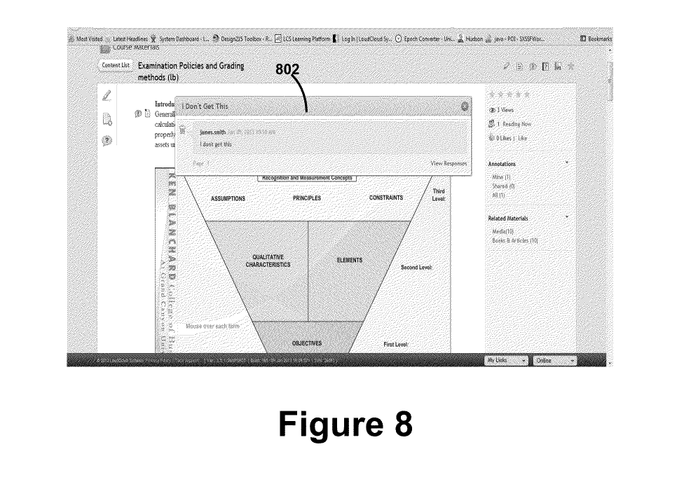

FIG. 8 illustrates a screenshot displaying a link 802 getting placed for “I don't get this” created by the user, in accordance with an embodiment of the present subject matter.

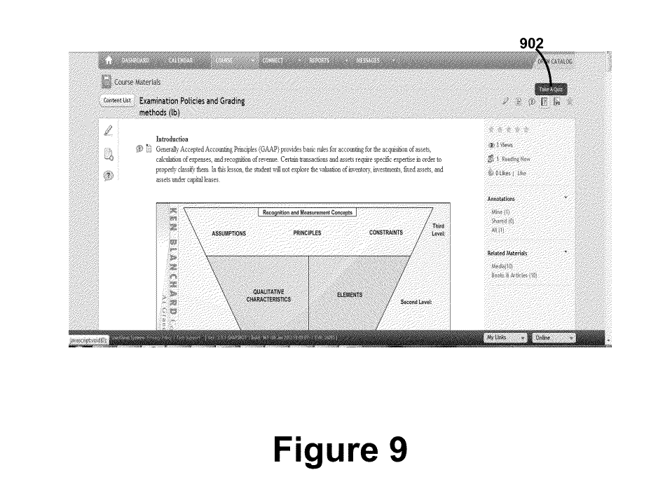

FIG. 9 illustrates a screenshot for communication with the interactive online learning technology using “Take a quiz” option 902, in accordance with an embodiment of the present subject matter.

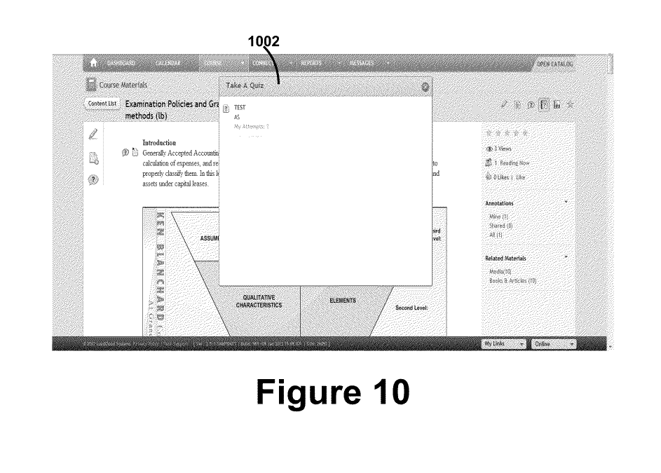

FIG. 10 illustrates a screenshot for displaying the action after user clicks 1002 on “Take a quiz” option 902, in accordance with an embodiment of the present subject matter.

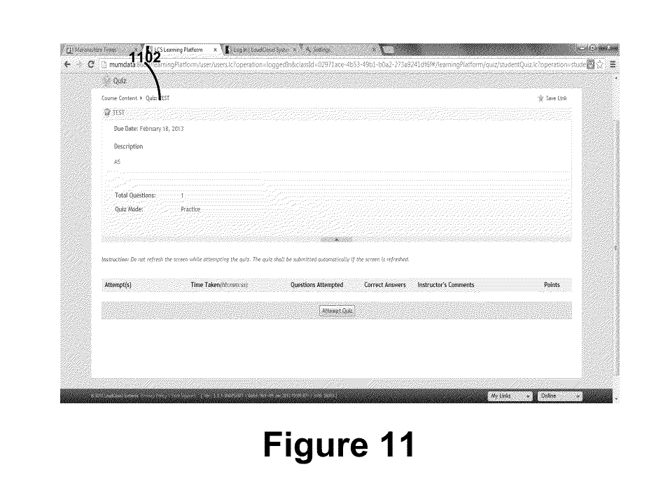

FIG. 11 illustrates a screenshot for displaying the action after user clicks 1002 the Quiz listed in the window 1102, in accordance with an embodiment of the present subject matter.

Although implementations for methods and systems for enhancing interactive online learning technology have been described in language specific to structural features and/or methods, it is to be understood that the appended claims are not necessarily limited to the specific features or methods described. Rather, the specific features and methods are disclosed as examples of implementations for enhancing interactive online learning technology.

I/We claim:

1. A method for transforming at least one input document with a source format to a document compatible with an interactive e-learning system, the method comprising:
transforming, by a processor, the at least one input document in an extensible markup language (XML) format;
parsing, by the processor, the at least one input document transformed using an extensible style sheet language transformation (XSLT);
creating, by the processor, a navigation order between a plurality of contents in the at least one input document, wherein the navigation order describes a relative path between the plurality of contents;
creating, by the processor, an asset file, based on the relative path between the plurality of contents;
tagging, by the processor, the plurality of contents in the at least one input document transformed to generate a plurality of tags;
storing the input document transformed comprising: the navigation order, the asset file and the plurality of tags, in a repository; and
enabling, by the processor, at least one user to communicate with at least one other user on the interactive e-learning system using the plurality of contents in the at least one input document, through an interface.

2. The method of claim 1, wherein the source format is selected from a group comprising rich text file format, Microsoft word file format, plain text file format, Microsoft power point file format, portable document format (PDF) file format, electronic publication (ePub) file format, and Docbook documentation.

3. The method of claim 1, wherein the plurality of contents in the at least one input document is selected from a group comprising a text, an audio, a video, an animation, and an image.

4. The method of claim 1, wherein the at least one input document transformed contains a set of presentation elements based on a XML document standard, and wherein the set of presentation elements comprise attributes, tables, schemas and combinations thereof.

5. The method of claim 1, wherein the navigation order created describes the relative path to navigation order created in the input document parsed, display title for each input document parsed, a hierarchical relationships between the contents in the input document parsed in form of a navigation tree.

6. The method of claim 5, wherein the relative path to the navigation order in the input document parsed is accessed using at least one of a uniform resource locator (URL) and a static link object.

7. The method of claim 1, wherein the communication between the at least one user and the at least one other user is enabled using at least one selected from a group comprising a discussion forum, a chat room, and a dashboard.

8. The method of claim 1, wherein the at least one user and the at least one other user is selected from a group comprising students, instructors, tutors, and administrators.

9. The method of claim 1, wherein the at least one user communicate with the at least one other user by posting a query related to the at least one content selected from the plurality of contents.

10. An interactive e-learning system for transforming at least one input document with a source format to a document compatible with the interactive e-learning system, the system comprising:
a processor;
an interface enabling at least one user to communicate with at least one other user on the interactive e-learning system; and
a memory coupled to the processor, wherein the processor is capable of executing a plurality of modules stored in the memory, and wherein the plurality of modules comprising:
a document transformation module configured to transform at least one input document in an extensible markup language (XML) format;
a document parser module configured to parse the at least one input document transformed using an extensible style sheet language transformation (XSLT);
a navigation file creation module configured to create a navigation order between a plurality of contents in the at least one input document parsed, wherein the navigation order describes a relative path between the plurality of contents;
an asset file creation module configured to create an asset file based on the relative path between the plurality of contents; and
a tagging module configured to tag the plurality of contents in the at least one input document transformed to generate a plurality of tags;
the memory further comprising a repository configured to store the input document transformed comprising: the navigation order, the asset file and the plurality of tags.

11. The interactive e-learning system of claim 10, further configured to enable the at least one user to read a content, create a content, store a content, mark a content and participate in a quiz embedded in a content.

12. The interactive e-learning system of claim 11, wherein the quiz includes various types of questions selected from a group comprising multiple choice questions, fill in the blank, and descriptive questions.

13. The interactive e-learning system of claim 11, wherein the quiz is embedded during the tagging of the input document transformed.

14. A computer program product having embodied thereon a computer program for transforming at least one input document with a source format to a document compatible with the interactive e-learning system, the computer program product comprising instructions for:
transforming the at least one input document in an extensible markup language (XML) format;
parsing the at least one input document transformed using an extensible style sheet language transformation (XSLT);
creating a navigation order between a plurality of contents in the at least one input document parsed, wherein the navigation order describes a relative path between the plurality of contents;
creating an asset file, based on the relative path between the plurality of contents;
tagging the plurality of contents in the at least one input document transformed to generate a plurality of tags;
storing the input document transformed comprising: the navigation order, the asset file and the plurality of tags, in a repository; and
enabling at least one user to communicate with at least one other user on the interactive e-learning system using the plurality of contents in the at least one input document, through an interface.
